(19) United States
(12) Patent Application Publication
(10) Pub. No.: US 2009/0163952 A1
(43) Pub. Date: Jun. 25, 2009

(54) Combination pacifier and hand cover

(76) Inventor: Michael D. Kash, Huntersville, NC (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/003,379

(22) Filed: Dec. 21, 2007

(51) Int. Cl. A61J 17/00; A41D 19/01; A41D 19/00; A43B 17/00

(52) U.S. Cl. 606/236; 2/158; 2/160; 2/239

(57) ABSTRACT

The combination pacifier and hand cover provides a mitten or similar garment having an attached pacifier, allowing an infant to wear the hand cover and suck on the nipple portion of the attached pacifier. The hand cover may be a sock, a mitten, a glove or any other suitable garment for covering the hand or foot of an infant. The hand cover includes opposed open and closed ends, with the hand cover defining an open interior region therein, which is dimensioned and configured to receive the hand of the infant. The closed end has an aperture formed therethrough. The pacifier includes a nipple portion and a grasping portion. The grasping portion is positioned within the open interior region of the hand cover, adjacent the closed end thereof, and the nipple portion projects through the aperture and extends outwardly from the hand cover.

### BACKGROUND OF THE INVENTION

1. Field of the Invention

The present invention relates to accessories for infant care, and particularly to a combination pacifier and hand cover that provides a mitten or similar hand cover having a pacifier attached thereto.

2. Description of the Related Art

Infants commonly insert their fingers (and sometimes toes) in their mouths, particularly when they are teething. Although pacifiers are well-known substitutes for fingers and toes, infants will often reject the use of a pacifier, and continue to suck on their fingers and toes. The covering of the infant's appendages with saliva is unsanitary and requires parents to expend additional time and energy for clean up. Thus, it would be desirable to provide a garment for covering the infant's hands (or feet), which would place the pacifier at the end of the infant's hand ready for use.

Further, infants commonly spit out the pacifier or drop the pacifier on the ground. The infant is often unable to locate the pacifier again, and often will place his or her hand in their mouth to suck on instead. Also, in order to prevent health and safety hazards, the pacifier must then be washed before being given back to the infant. It would be desirable to attach the pacifier to the infant's person in such a manner that the infant's natural instinct to place his or her hand (or foot) into the mouth will result in placing the pacifier back into the infant's mouth.

Thus, a combination pacifier and hand cover solving the aforementioned problems is desired.

### SUMMARY OF THE INVENTION

The combination pacifier and hand cover provides a mitten or similar garment having an attached pacifier, allowing an infant to wear the hand cover and suck on the nipple portion of the attached pacifier. The hand cover may be a sock, a mitten, a glove or any other suitable garment for covering the hand or foot of an infant.

The hand cover has opposed open and closed ends, with the hand cover defining an open interior region therein, which is dimensioned and configured to receive the hand (or foot) of the infant. Preferably, an annular elastic band is secured to the hand cover adjacent the open end thereof, allowing for comfortable attachment about the arm of the infant. The closed end has an aperture formed therethrough.

A conventional pacifier is further provided. The pacifier includes a nipple portion and a grasping portion. The grasping portion is positioned within the open interior region of the hand cover adjacent the closed end thereof, and the nipple portion projects through the aperture and extends outwardly from an external surface of the hand cover.

In use, the hand cover is dimensioned and configured to receive the infant's hand within the open interior region thereof, and the grasping portion of the pacifier is adapted for grasping by the infant's hand. The infant may then suck on the nipple portion, with the pacifier being secured to the infant's hand (or foot).

These and other features of the present invention will become readily apparent upon further review of the following specification and drawings.

### BRIEF DESCRIPTION OF THE DRAWINGS

FIG. 1 is an environmental, perspective view of a combination pacifier and hand cover according to the present invention.

FIG. 2 is a perspective view of the combination pacifier and hand cover according to the present invention.

FIG. 3 is a perspective view, partially broken away and in section, of the combination pacifier and hand cover according to the present invention.

Similar reference characters denote corresponding features consistently throughout the attached drawings.

### DETAILED DESCRIPTION OF THE PREFERRED EMBODIMENTS

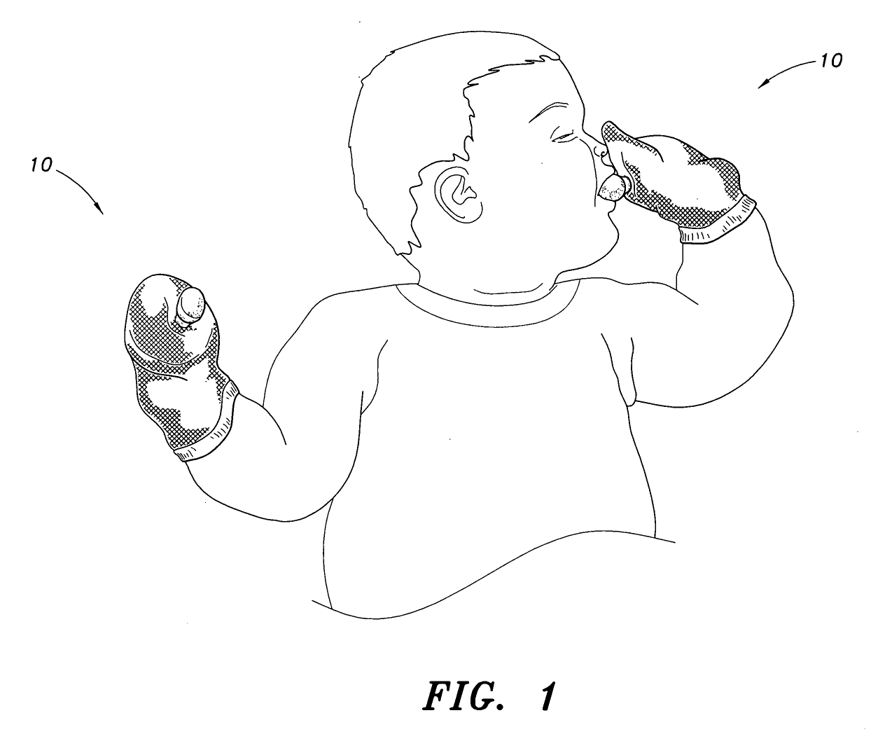

The present invention is directed towards a combination pacifier and hand cover 10. As shown in FIG. 1, the combination pacifier and hand cover 10 provides a mitten or similar garment having an attached pacifier, allowing an infant to wear the hand cover and suck on the nipple portion of the attached pacifier. The hand cover may be a sock, a mitten, a glove or any other suitable garment for covering the hand or foot of an infant. Alternatively, a band or strap may be utilized for retaining the hand cover about the wrist or ankle of the infant. In FIGS. 1-3, the hand cover 12 is shown as being a sock-like garment, although it should be understood that any suitable hand, or, alternatively, foot) covering garment may be utilized. The hand cover is dimensioned and configured to be worn over an infant's hand (or foot) and is preferably formed from materials that are comfortable and safe for use with infants, such as soft cotton.

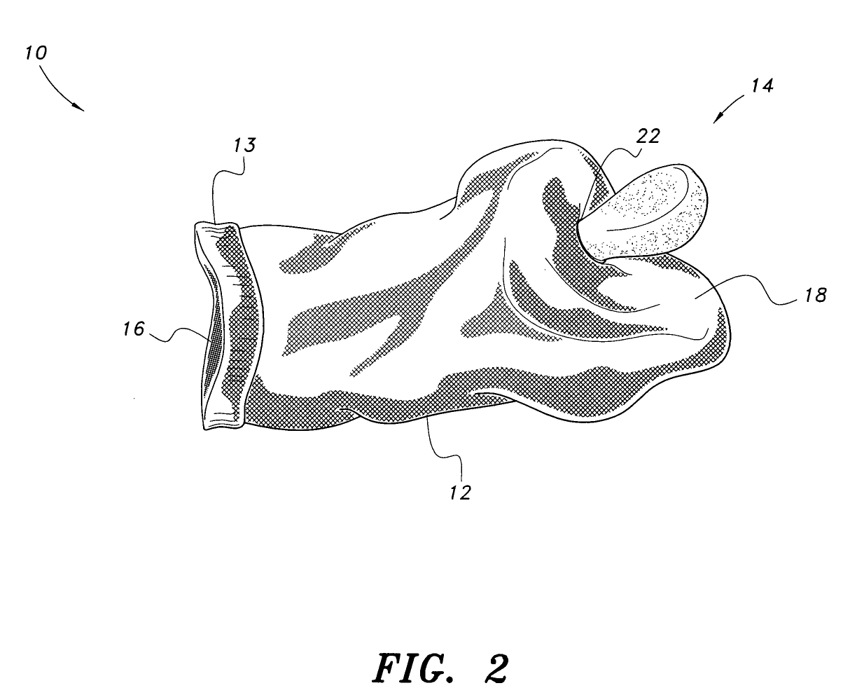

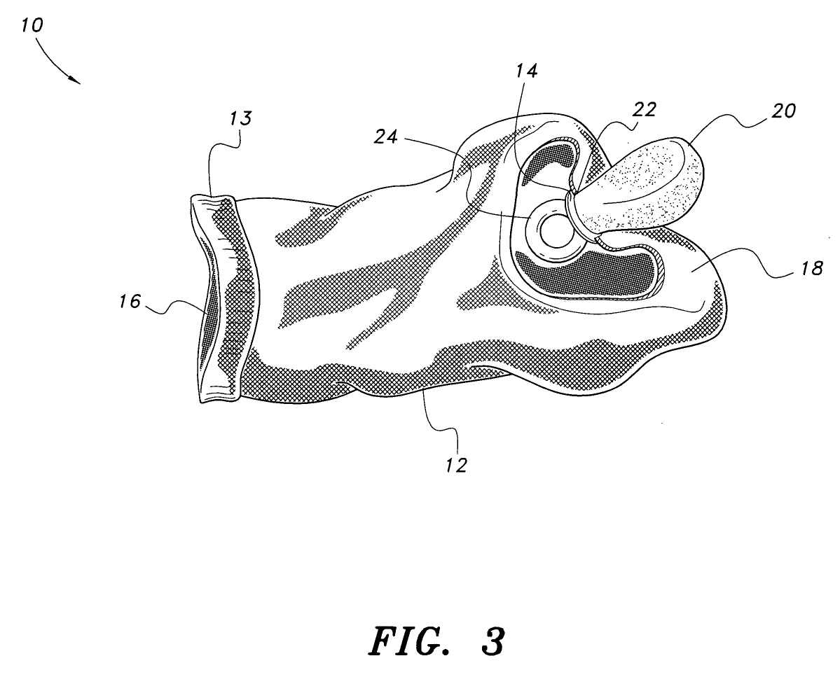

As best shown in FIGS. 2 and 3, the hand cover 12 has opposed open and closed ends 16, 18, respectively, with the hand cover 12 defining an open interior region therein, which is dimensioned and configured to receive the hand (or foot) of the infant. Preferably, an annular elastic band 13 is secured to the hand cover 12 adjacent the open end 16 thereof, allowing for comfortable attachment about the wrist or forearm of the infant. The closed end 18 has an aperture 22 formed therethrough.

A conventional pacifier 14 is further provided. As shown in FIG. 3, the pacifier 14 includes a nipple portion 20 and a grasping portion 24. The pacifier 14 illustrated in the drawings is shown for exemplary purposes only, and it should be understood that any suitable pacifier having any suitable dimensions or configuration may be used. The grasping portion 24 is positioned within the open interior region of the hand cover 12 adjacent the closed end 18 thereof, and the nipple portion 20 projects through the aperture 22 and extends outwardly from an external surface of the hand cover 12. In the exemplary figures the nipple portion 20 projects outwardly from the longitudinal end of the hand cover 12. However, it should be understood that the pacifier 14 may be positioned in any suitable location with respect to hand cover 12. For example, the nipple 14 may be positioned so that it projects outwardly from the infant's palm, rather than the tips of the infant's fingers.

In use, the hand cover 12 is dimensioned and configured to receive the infant's hand within the open interior region thereof, and the grasping portion 24 of the pacifier 14 is adapted for grasping by the infant's hand. The infant may then suck on the nipple portion 20 (as shown in FIG. 1), with the pacifier 14 being secured to the infant's hand (or foot). In FIG. 1, a pair of combination pacifier and hand covers 10 are shown secured to the infant. It should be understood that the combination pacifier and hand cover 10 may be used as a single item, on one hand (or foot) of the infant, or may be provided as multiple items for use with multiple hands (or feet) of the infant. In use, the combination pacifier and hand cover 10 allows for safe, comfortable and sanitary attachment of the pacifier to the infant, prevents the infant from sucking on his or her fingers or toes, and further aids in the development of the infant's motor skills as he or she inserts and removes the pacifier from his or her mouth.

It is to be understood that the present invention is not limited to the embodiments described above, but encompasses any and all embodiments within the scope of the following claims.

I claim:

1. A combination pacifier and hand cover, comprising:
a hand cover having opposed open and closed ends, the hand cover defining an open interior region therein, the closed end having an aperture formed therethrough; and
a pacifier having a nipple portion and a grasping portion, the grasping portion thereof being positioned within the open interior region of the hand cover, the nipple portion projecting through the aperture and extending outwardly from an external surface of the hand cover, the hand cover being dimensioned and configured for receiving an infant's hand within the open interior region thereof, the grasping portion of the pacifier being adapted for grasping by the infant's hand.

2. The combination pacifier and hand cover as recited in claim 1, further comprising an annular elastic band attached to said hand cover adjacent the open end thereof.

3. The combination pacifier and hand cover as recited in claim 1, wherein said hand cover is a garment selected from the group consisting of: a mitten, a glove and a sock.

4. The combination pacifier and hand cover as recited in claim 1, wherein said hand cover is formed from a flexible material.

5. The combination pacifier and hand cover as recited in claim 4, wherein said hand cover is made from cotton.
